(19) United States
(12) Patent Application Publication
(10) Pub. No.: US 2026/0187742 A1
(43) Pub. Date: Jul. 2, 2026

(54) INFORMATION PROCESSING DEVICE, INFORMATION PROCESSING METHOD, AND NON-TRANSITORY STORAGE MEDIUM STORING INFORMATION PROCESSING PROGRAM

(71) Applicant: TOYOTA JIDOSHA KABUSHIKI KAISHA, Toyota-shi (JP)

(72) Inventor: Yorichika Ishiyama, Nagoya-shi (JP)

(73) Assignee: TOYOTA JIDOSHA KABUSHIKI KAISHA, Toyota-shi (JP)

(21) Appl. No.: 19/408,620

(22) Filed: Dec. 4, 2025

(30) Foreign Application Priority Data
Dec. 26, 2024 (JP) 2024-231079

(51) Int. Cl. G06Q 50/18

(52) U.S. Cl. CPC G06Q 50/184

(57) ABSTRACT

The server extracts a characteristic part of the disclosure described in the independent claim in the patent document. The server acquires the investigation result output from the generative model by inputting, to the generative model, an instruction text for instructing an investigation of the relevance between the characteristic part and the technical information. The server outputs the investigation result.

### CROSS-REFERENCE TO RELATED APPLICATION

This application claims priority to Japanese Patent Application No. 2024-231079 filed on Dec. 26, 2024. The disclosure of the above-identified application, including the specification, drawings, and claims, is incorporated by reference herein in its entirety.

### BACKGROUND

### 1. Technical Field

The present disclosure relates to an information processing device, an information processing method, and a non-transitory storage medium storing an information processing program.

### 2. Description of Related Art

Japanese Unexamined Patent Application Publication No. 2011-96200 (JP 2011-96200 A) discloses a technique for supporting understanding of claims in a patent document.

### SUMMARY

Meanwhile, in a case where generative AI (Artificial Intelligence) is used to investigate whether a technical feature related to a patent is present in target technical information (or to investigate a portion where such a technical feature is present).

In such a case, for example, the contents of the claims described in the claims in the patent document and the target technical information are first input to the generative AI. Next, for example, an instruction text for instructing an investigation of relevance between the contents of the claims and the target technical information is input to the generative AI. Specifically, the instruction text for investigating whether information related to the contents of the claims is present in the target technical information (or where in the technical information such information related to the contents of the claims is present) is input to the generative AI. In response to the instruction text, the generative AI outputs an investigation result indicating whether information related to the contents of the claims is present in the target technical information (or where in the technical information such information related to the contents of the claims is present). In this way, it is possible to investigate the relevance between the contents of the claims and the target technical information by using the generative AI.

However, in claims in the patent document, a characteristic part of the disclosure and a non-characteristic part of the disclosure are often described. Therefore, in a case where the contents of the claims are directly input to the generative AI, the generative AI may investigate whether the non-characteristic part of the disclosure is present in the target technical information. In particular, since an independent claim in the patent document often describes a premise portion for establishing the disclosure, the accuracy of the investigation result may be reduced in a case where the content of the independent claim is directly input to the generative AI.

The technique disclosed in JP 2011-96200 A is a technique for supporting understanding of claims in a patent document, and is not a technique for investigating the relevance between the patent document and the target technical information.

The present disclosure is made in view of the above, and an object of the present disclosure is to provide an information processing device, an information processing method, and a non-transitory storage medium storing an information processing program capable of accurately investigating relevance between a patent document and target technical information.

An information processing device according to a first aspect of the present disclosure is an information processing device including: an extraction unit configured to extract a characteristic part of a disclosure described in an independent claim in a patent document; an acquisition unit configured to acquire an investigation result output from a generative model by inputting, to the generative model, an instruction text for instructing an investigation of relevance between the characteristic part and technical information; and an output unit configured to output the investigation result. With the information processing device according to the first aspect of the present disclosure, it is possible to accurately investigate the relevance between the patent document and the target technical information.

An information processing device according to a second aspect of the present disclosure is the information processing device according to the first aspect, in which the acquisition unit is configured to acquire the investigation result output from the generative model by inputting, to the generative model, at least a portion of descriptions of dependent claims in the patent document. With the information processing device according to the second aspect of the present disclosure, it is possible to more accurately investigate the relevance between the patent document and the target technical information by taking the descriptions of the dependent claims into consideration.

An information processing device according to a third aspect of the present disclosure is the information processing device according to the first aspect or the second aspect. The extraction unit is configured to acquire the characteristic part output from the generative model by inputting, to the generative model, an instruction text for instructing extraction of the characteristic part. The acquisition unit is configured to acquire the investigation result output from the generative model by inputting, to the generative model, at least one of an instruction text for instructing an investigation of whether a technical feature related to the characteristic part is present in the technical information and an instruction text for instructing an investigation of a portion of the technical information where the technical feature related to the characteristic part is present. With the information processing device according to the third aspect of the present disclosure, it is possible to accurately investigate whether the disclosure described in the independent claim in the patent document is present in the technical information. Further, with the information processing device according to the third aspect of the present disclosure, it is possible to accurately investigate a portion of the technical information where the technical feature related to the characteristic part is present.

An information processing method according to a fourth aspect of the present disclosure is an information processing method including causing a computer to execute a process of: extracting a characteristic part of a disclosure described in an independent claim in a patent document; acquiring an investigation result output from a generative model by inputting, to the generative model, an instruction text for instructing an investigation of relevance between the characteristic part and technical information; and outputting the investigation result. With the information processing method according to the fourth aspect of the present disclosure, it is possible to accurately investigate the relevance between the patent document and the target technical information.

A non-transitory storage medium storing an information processing program according to a fifth aspect of the present disclosure is a non-transitory storage medium storing an information processing program causing a computer to execute a process of: extracting a characteristic part of a disclosure described in an independent claim in a patent document; acquiring an investigation result output from a generative model by inputting, to the generative model, an instruction text for instructing an investigation of relevance between the characteristic part and technical information; and outputting the investigation result. With the non-transitory storage medium storing the information processing program according to the fifth aspect of the present disclosure, it is possible to accurately investigate the relevance between the patent document and the target technical information.

According to the present disclosure, it is possible to provide an information processing device, an information processing method, and a non-transitory storage medium storing an information processing program capable of accurately investigating relevance between a patent document and target technical information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a functional configuration example of an information processing system according to an embodiment of the disclosed technique;

FIG. 2 is a block diagram showing a hardware configuration of a server; and

FIG. 3 is a flowchart showing a flow of information processing by the server.

### DETAILED DESCRIPTION OF EMBODIMENTS

Hereinafter, an example of an embodiment of the present disclosure will be described with reference to the drawings. In addition, the identical or equivalent components and portions in each drawing are denoted by the same reference numerals. Further, the dimensional ratios in the drawings are exaggerated for convenience of explanation, and may differ from the actual ratios.

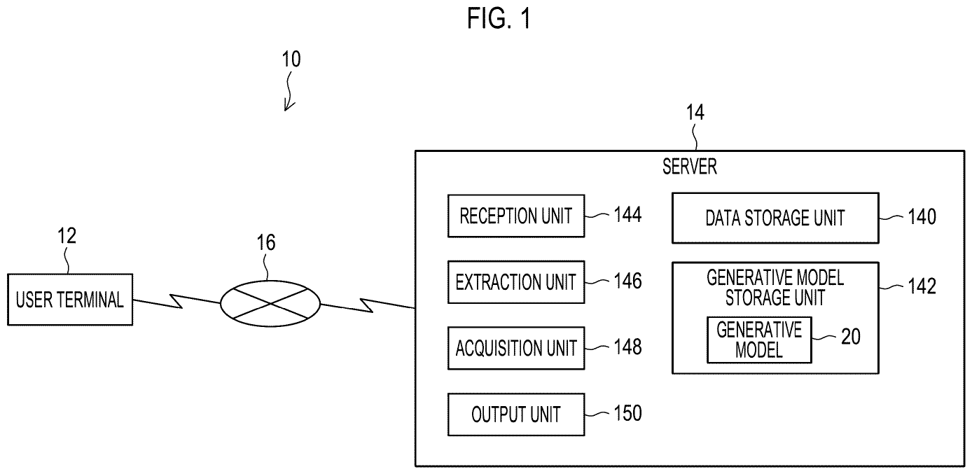

FIG. 1 is a block diagram showing an example of a functional configuration of an information processing system 10 according to the embodiment. As shown in FIG. 1, the information processing system 10 includes a user terminal 12 and a server 14 that is an example of an information processing device. The user terminal 12 and the server 14 are communicably connected to each other via a network 16, such as the Internet.

The information processing system 10 according to the present embodiment is a system for investigating the relevance between the disclosure described in claims in the patent document and the target technical information. The patent document refers to a document related to a patent, such as a published unexamined patent application or a patent bulletin. The patent document generally includes claims, a detailed description of the disclosure, an abstract, and drawings.

The server 14 causes a generative model that is a known generative AI to read a patent document and technical information to be compared with the patent document, provides a predetermined instruction text (prompt) to the generative model, and causes the generative model to output a correspondence relationship between the disclosure described in claims in the patent document and the technical information.

The technical information is at least one of textual information, image information, and video information in which the technical matter is expressed. The textual information is information in which the technique is expressed through texts. For example, a patent document, a technical specification, a technical specification sheet, a product manual, a product brochure, and the like are examples of the textual information. The image information is information in which the technique is expressed through images. For example, a drawing of a product in which the technique is embodied is an example of the image information. In addition, the video information is information in which the technique is expressed through videos. For example, a video or the like recorded when operating a product or the like in which the technique is embodied is an example of the video information.

As described above, when the relevance between the patent document and the target technical information is investigated by using the generative AI, for example, the contents of claims in the patent document and the target technical information are first input to the generative AI.

Here, for example, a case where the content of the claim is “a control device that controls X, the control device comprising A, B, and C” is considered. In such a case, the “control device that controls X” is a portion referred to as a preamble, and is not a characteristic part of the disclosure, but corresponds to a premise portion for establishing the disclosure. For example, among the components A, B, and C of the disclosure, A and C may also not be characteristic parts of the disclosure. Therefore, it is also conceivable that, in the content of the claim, “a control device that controls X, the control device comprising A, B, and C”, solely the component B of the disclosure is the point of the disclosure and serves as a characteristic part. Alternatively, it is also conceivable that a part of component A of the disclosure and a part of component B of the disclosure constitute the point of the disclosure and serve as the characteristic part.

In such a case, when the content of the claim “a control device that controls X, the control device comprising A, B, and C” is directly input to the generative AI, the generative AI may, for example, not search for the component B that is a characteristic part of the disclosure in the technical information. In addition, it is also conceivable that a preamble component “a control device that controls X” is searched for within the technical information, and an investigation result indicating that the technical information includes a description of a technical feature related to the claim is output. Such a state can be said to be a state in which noise is included in the input of the generative AI, and as a result, noise is also included in the investigation result, and the accuracy of the investigation result is reduced.

Therefore, in the present embodiment, the characteristic part of the disclosure described in the independent claim is extracted before the generative AI investigates the relevance between the patent document and the technical information. In the present embodiment, the relevance between the content of the claim and the technical information is investigated using the generative AI by inputting, to the generative AI, the characteristic part of the disclosure extracted from the independent claim. As a result, the noise included in the information input to the generative AI is reduced, and the noise included in the investigation result is also reduced, so that the accuracy of the investigation result is improved. Hereinafter, the present disclosure will be specifically described.

### User Terminal

The user terminal 12 is operated by the user. The user terminal 12 exchanges information with the server 14 in response to an operation by the user.

### Server

Functionally, as shown in FIG. 1, the server 14 includes a data storage unit 140, a generative model storage unit 142, a reception unit 144, an extraction unit 146, an acquisition unit 148, and an output unit 150.

The data storage unit 140 stores various data received by the reception unit 144 and data used for the processing described below. For example, the data storage unit 140 stores data of the patent document, the target technical information, and other data.

The generative model storage unit 142 stores the generative model 20, an example of a generative AI. The generative model 20 is a trained model that has been machine-learned in advance to generate and output a text, an image, or the like in response to an input. For example, the generative model 20 may use any of the GPT series (e.g., GPT-3, GPT-4), BERT, or RoBERTa as a model that generates a text in response to input. The generative model 20 may be stored in a device different from the server 14. In this case, the server 14 uses the generative model 20 by accessing another device on which the generative model 20 operates. In the present embodiment, a case will be described in which the generative model 20 is stored in the generative model storage unit 142, an example of the storage unit of the server 14.

The reception unit 144 receives the input data from the outside. For example, the reception unit 144 receives various data transmitted from the user terminal 12. Alternatively, for example, the reception unit 144 receives various data downloaded from an external database (not shown) in response to the instruction transmitted from the user terminal 12. For example, the reception unit 144 receives the patent number of the patent document transmitted from the user terminal 12 as various data, and downloads the patent publication data corresponding to the patent number from an external database (not shown). For example, the reception unit 144 receives the target technical information as various data. For example, the reception unit 144 stores various data in the data storage unit 140.

The extraction unit 146 extracts a characteristic part of the disclosure described in the independent claim in the patent document. Specifically, the extraction unit 146 acquires a characteristic part output from the generative model 20 by inputting, to the generative model 20, an instruction text for instructing the extraction of a characteristic part of the disclosure described in an independent claim.

For example, the instruction text includes the description of the independent claim. For example, the extraction unit 146 inputs an instruction text [<Insert description of the independent claim>Please extract the point (or characteristic part) of the disclosure in the claims] to the generative model 20. Then, the characteristic part of the disclosure according to the independent claim output from the generative model 20 is acquired. The generative model 20 outputs information such as [Point 1: XXX, Point 2: YYY].

The acquisition unit 148 inputs, to the generative model 20, an instruction text for instructing the investigation of the relevance between the characteristic part extracted by the extraction unit 146 and the target technical information stored in the data storage unit 140. Then, the investigation result output from the generative model 20 is acquired.

For example, the acquisition unit 148 inputs, to the generative model 20, an instruction text for instructing the investigation of whether the technical feature related to the characteristic part extracted by the extraction unit 146 is present in the target technical information stored in the data storage unit 140. The generative model 20 outputs an investigation result indicating whether a technical feature related to the characteristic part is present in the target technical information.

Alternatively, for example, the acquisition unit 148 inputs, to the generative model 20, an instruction text for instructing the investigation of a portion of the target technical information where a technical feature related to the characteristic part is present. The generative model 20 outputs an investigation result regarding a portion of the target technical information where a technical feature related to the characteristic part is present.

For example, the instruction text includes a description of the characteristic part. For example, the acquisition unit 148 inputs, to the generative model 20, an instruction text such as: [<Insert the point of the disclosure (description of the characteristic part)> <Insert technical information similar to the point of the disclosure (description of the characteristic part)>In the technical information, is there any description that is similar to part of the point of the disclosure through inference and broad interpretation?]. Then, the investigation result output from the generative model 20 is acquired. The generative model 20 outputs, for example, information such as [{Determination: Yes, Reason: AAA, Original text of the described portion: WWW}, {Determination: No, Reason: BBB, Original text of the described portion: ZZZ}].

When investigating the relevance between the characteristic part extracted by the extraction unit 146 and the technical information, the acquisition unit 148 may vectorize the characteristic part and the technical information and then investigate the relevance between the characteristic part and the technical information to be stored in the data storage unit 140. For example, the acquisition unit 148 vectorizes the text corresponding to the characteristic part using a known vectorization technique, and also vectorizes the information present in each portion in the technical information using a known vectorization technique. For example, in a case where the technical information is textual information, each text described in each paragraph is vectorized. For example, in a case where the technical information is image information, each partial image of each portion constituting the image is vectorized. For example, in a case where the technical information is video information, each frame image constituting the video is vectorized. Then, the acquisition unit 148 calculates a similarity between the vector of the characteristic part and each vector of the information present in each portion in the technical information, and inputs, to the generative model 20, as target technical information for investigation, solely the technical information in a portion where the similarity is equal to or greater than a predetermined threshold. For example, in the instruction text described above, solely the technical information in a portion where the similarity is equal to or greater than a predetermined threshold is inserted into the part <Insert technical information similar to the point of the disclosure (description of the characteristic part)>. As a result, solely the technical information in a portion where the similarity to the characteristic part is equal to or greater than a predetermined threshold is investigated, without investigating all of the information present in each portion in the technical information, thereby potentially improving the accuracy of the investigation result.

The output unit 150 outputs the investigation result acquired by the acquisition unit 148.

The investigation result output from the output unit 150 is transmitted to the user terminal 12.

The user operates the user terminal 12 to check the investigation result displayed on a display unit (not shown) of the user terminal 12.

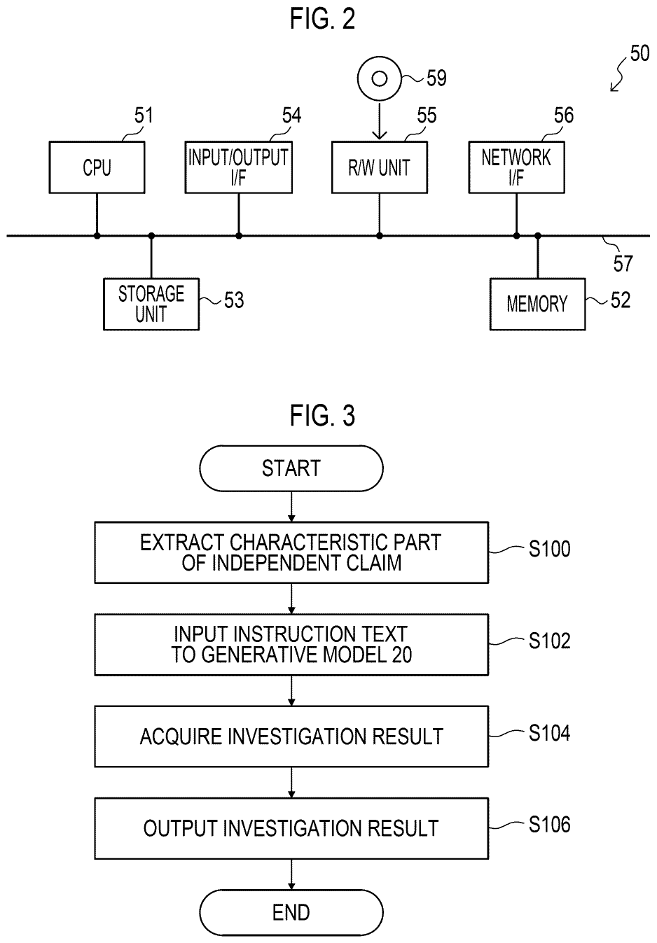

The user terminal 12 and the server 14 can be implemented, for example, by a computer 50 as shown in FIG. 2. The computer 50 that implements the user terminal 12 and the server 14 includes a CPU 51, a memory 52 as a temporary storage area, and a non-volatile storage unit 53. The computer 50 includes an input/output interface (I/F) 54 to which an input/output device or the like (not shown) is connected, and a read/write (R/W) unit 55 that controls reading and writing of data to a recording medium 59. The computer 50 includes a network I/F 56 connected to a network, such as the Internet. The CPU 51, the memory 52, the storage unit 53, the input/output I/F 54, the R/W unit 55, and the network I/F 56 are connected to each other via a bus 57.

The storage unit 53 can be implemented by a hard disk drive (HDD), a solid state drive (SSD), a flash memory, or the like. The storage unit 53, serving as a storage medium, stores a program for causing the computer to function. The CPU 51 reads the program from the storage unit 53 and loads the program into the memory 52, and sequentially executes the processes included in the program.

Therefore, each functional configuration of the server 14 is implemented by the CPU 51 reading out and executing the information processing program stored in the memory 52 or the storage unit 53.

Next, the operation of the information processing system 10 of the embodiment will be described.

FIG. 3 is a flowchart showing a flow of information processing by the server 14. The information processing is performed by the CPU 11 reading from an information processing program from the storage unit 53, loading the program into the memory 52, and executing the program.

In step S100, the extraction unit 146 reads the data of the patent document stored in the data storage unit 140. In step S100, the extraction unit 146 extracts the characteristic part of the disclosure described in the independent claim in the patent document. Specifically, in step S100, the extraction unit 146 acquires a characteristic part output from the generative model 20 by inputting, to the generative model 20, an instruction text for instructing the extraction of a characteristic part of the disclosure described in an independent claim.

In step S102, the acquisition unit 148 inputs, to the generative model 20, the instruction text for instructing the investigation of the relevance between the characteristic part extracted in step S100 and the target technical information stored in the data storage unit 140.

In step S104, the acquisition unit 148 acquires the investigation result output from the generative model 20.

In step S106, the output unit 150 outputs the investigation result acquired in step S104.

As described above, the server of the information processing system according to the embodiment extracts the characteristic part of the disclosure described in the independent claim in the patent document. The server acquires the investigation result output from the generative model by inputting, to the generative model, an instruction text for instructing an investigation of the relevance between the characteristic part and the technical information. The server outputs the investigation result. As a result, it is possible to accurately investigate the relevance between the patent document and the target technical information.

The server acquires the characteristic part output from the generative model by inputting, to the generative model, an instruction text for instructing the extraction of the characteristic part. Then, the server inputs, to the generative model, at least one of an instruction text for instructing an investigation of whether a technical feature related to the characteristic part is present in the target technical information, and an instruction text for instructing an investigation of a portion of the technical information where a technical feature related to the characteristic part is present. The server acquires the investigation result output from the generative model. As a result, it is possible to accurately investigate whether the disclosure described in the independent claim in the patent document is present in the technical information. In addition, it is possible to accurately investigate a portion of the technical information where a technical feature related to the characteristic part is present.

Although the embodiment of the present disclosure has been described in detail with reference to the accompanying drawings, the technical scope of the present disclosure is not limited to the examples. The embodiment described above is exemplary and does not limit the technical scope of the present disclosure. It is apparent that those of ordinary skill in the art to which the present disclosure pertains can conceive of various modifications or corrections within the scope of the technical concept described in the claims, and such modifications or corrections are naturally understood to fall within the technical scope of the present disclosure.

For example, the following modifications can be given.

### Modification 1

In the embodiment, an example has been described in which a characteristic part of the disclosure described in an independent claim is extracted, and an investigation result output from the generative model is acquired by inputting, to the generative model, an instruction text for instructing an investigation of the relevance between the characteristic part and technical information. However, the present disclosure is not limited thereto. Since the content of the independent claim is often abstract, the accuracy of the investigation result may be reduced when solely the independent claim is input to the generative model. Therefore, for example, it is also possible to acquire an investigation result output from the generative model by inputting, to the generative model, at least a portion of descriptions of the dependent claims in the patent document. Since the dependent claims are often more specific than the independent claim, the dependent claims may describe the characteristic part of the disclosure in a more specific manner. Therefore, it is possible to more accurately investigate the relevance between the patent document and the target technical information by inputting, to the generative model, at least a portion of descriptions of the dependent claims in the patent document. On the other hand, in a case where the entire specification portion in the patent document is input to the generative model 20, the accuracy of the investigation result is assumed to be reduced because many parts different from the characteristic part of the disclosure are described.

### Modification 2

In the embodiment, in a case where the target technical information is image information or video information, an example has been described in which the information is directly input to the generative model 20. However, the present disclosure is not limited thereto. For example, in a case where the target technical information is image information or video information, the image information or the video information may be once converted into text by using a known technique and then input to the generative model 20. For example, the image information or the video information can be converted into text using the generative model 20.

The effects described in the embodiment are explanatory or exemplary, and are not limited to those described in the embodiment described above. In other words, the technique according to the present disclosure may achieve other effects that are apparent to those skilled in the art based on the description in the embodiment described above, together with or instead of the effects described in the embodiment described above.

Various processors other than the CPU may execute the information processing executed by the CPU reading and executing software (program) in each of the embodiments described above. Examples of the processor in this case include a programmable logic device (PLD), such as a field-programmable gate array (FPGA) that can change a circuit configuration after manufacturing, and a dedicated electric circuit that is a processor having a circuit configuration designed to execute a specific process, such as an application specific integrated circuit (ASIC). The information processing may be executed by one of the various processors, or may be executed by a combination of two or more processors of the same type or different types (for example, a plurality of FPGAs, and a combination of a CPU and an FPGA). The hardware structure of these various processors is more specifically an electrical circuit in which circuit elements, such as semiconductor elements, are combined.

In addition, in each of the embodiments described above, an aspect in which the information processing program is stored (installed) in the storage unit in advance has been described, but the present disclosure is not limited thereto. The program may be provided in a form recorded on a non-transitory recording medium, such as a compact disk read only memory (CD-ROM), a digital versatile disk read only memory (DVD-ROM), or a universal serial bus (USB) memory. The program may also be in a form downloaded from an external device via a network. In addition, the present disclosure may be applied to a program product.

What is claimed is:

1. An information processing device comprising:
an extraction unit configured to extract a characteristic part of a disclosure described in an independent claim in a patent document;
an acquisition unit configured to acquire an investigation result output from a generative model by inputting, to the generative model, an instruction text for instructing an investigation of relevance between the characteristic part and technical information; and
an output unit configured to output the investigation result.

2. The information processing device according to claim 1, wherein the acquisition unit is configured to acquire the investigation result output from the generative model by inputting, to the generative model, at least a portion of descriptions of dependent claims in the patent document.

3. The information processing device according to claim 1, wherein:
the extraction unit is configured to acquire the characteristic part output from the generative model by inputting, to the generative model, an instruction text for instructing extraction of the characteristic part; and
the acquisition unit is configured to acquire the investigation result output from the generative model by inputting, to the generative model, at least one of an instruction text for instructing an investigation of whether a technical feature related to the characteristic part is present in the technical information and an instruction text for instructing an investigation of a portion of the technical information where the technical feature related to the characteristic part is present.

4. An information processing method comprising causing a computer to execute a process of:
extracting a characteristic part of a disclosure described in an independent claim in a patent document;
acquiring an investigation result output from a generative model by inputting, to the generative model, an instruction text for instructing an investigation of relevance between the characteristic part and technical information; and
outputting the investigation result.

5. A non-transitory storage medium storing an information processing program causing a computer to execute a process of:
extracting a characteristic part of a disclosure described in an independent claim in a patent document;
acquiring an investigation result output from a generative model by inputting, to the generative model, an instruction text for instructing an investigation of relevance between the characteristic part and technical information; and
outputting the investigation result.
